(19) United States
(12) Patent Application Publication
(10) Pub. No.: US 2026/0307118 A1
(43) Pub. Date: Oct. 8, 2026

(54) CLEANING DEVICE AND METHOD FOR CLEANING WASTEWATER HOLDING TANKS

(71) Applicant: Williams Company Enterprises, LLC, Springfield, MO (US)

(72) Inventor: Rick Williams, Springfield, MO (US)

(21) Appl. No.: 19/444,044

(22) Filed: Jan. 8, 2026

Related U.S. Application Data
(60) Provisional application No. 63/743,074, filed on Jan. 8, 2025.

(51) Int. Cl. B08B 9/087; B05B 13/04; B05B 13/06; B08B 9/093

(52) U.S. Cl. CPC B08B 9/087; B05B 13/04; B05B 13/06; B08B 9/093; B08B 2209/08

(57) ABSTRACT

A cleaning device and a method of using the same is provided. A cleaning portion of the cleaning device includes a primary tube, an impact feature positioned at or near a distal end of the primary tube, and a fluid outlet positioned at or near the impact feature. The cleaning portion of the cleaning device is positioned within an inner cavity of a holding tank, such as a wastewater holding tank of a recreational vehicle, and fluid is caused to flow through the cleaning device such that a high pressure jet of fluid exiting the fluid outlet of the cleaning device causes the impact feature to move around erratically within the inner cavity of the holding tank, thereby impacting and rinsing various interior surfaces of the holding tank. This impacting and rinsing of the interior surfaces of the holding tank facilitates removal of residue and debris from the holding tank.

### CROSS-REFERENCE TO RELATED APPLICATIONS

This application claims priority pursuant to 35 U.S.C. 119(e) to U.S. Provisional Patent Application Ser. No. 63/743,074, filed Jan. 8, 2025, the entire disclosure of which is incorporated herein by reference.

### FIELD OF THE INVENTION

The present invention relates generally to cleaning devices and methods of using the same. More specifically, the present invention is concerned with an apparatus for, and a method of, cleaning wastewater holding tanks.

### BACKGROUND

Recreational vehicles, such as motorhomes and the like, regularly have one or more holding tank for holding wastewater, such as grey water from showers and sinks and sewage from toilets. These holding tanks are routinely filled and emptied, sometimes resulting in residue and debris, such as toilet paper and the like, building up within an inner cavity of the tank. This residue and debris can lead to various complications, such as clogging, improper reading of holding tank sensors, and an odor that can infiltrate the cabin. Accordingly, it would be beneficial to have a device for and a method of cleaning residue and debris from the inner cavity of a holding tank.

Properly cleaning the interior of a holding tank is difficult for several reasons. In some instances, the holding tank is located on the interior of the recreational vehicle without easy access for a user to reach it for cleaning. Furthermore, holding tanks tend to have a limited number of ports, providing few options for accessing the inner cavity of the tank. Even if the inner cavity of a wastewater holding tank could be reached by a user, doing so by hand is undesirable due to the nature of the holding tank's contents and resulting sanitary concerns. Accordingly, it would be beneficial to have a device for and a method of easily and sanitarily accessing the inner cavity of a holding tank.

Existing solutions for cleaning wastewater holding tanks involve flushing a holding tank, such as by connecting a flush valve to a gate valve of the recreational vehicle and running water through the flush valve and the gate valve into the holding tank. While presumably satisfactory for its intended purpose, flushing the holding tank requires a large volume of clean or grey water to fill the holding tank, thereby creating a large volume of wastewater, such as sewage wastewater, that must be properly disposed of. Accordingly, it would be beneficial to have a device for and a method of cleaning a wastewater holding tank without creating a large volume of wastewater.

### SUMMARY

The present invention includes a device for and a method of cleaning residue and debris from the inner cavity of a holding tank, such as a wastewater holding tank for a recreational vehicle. In some such embodiments, the device and method facilitate easy and sanitary access to an inner cavity of the holding tank. In some embodiments, the device and method of the present invention requires just a small volume of fluid to adequately clean an inner cavity of a large wastewater holding tank.

The present invention is a water powered cleaning device having a cleaning portion extending from a positioning portion. The positioning portion is configured to facilitate positioning the cleaning portion within an inner cavity of a holding tank, and the cleaning portion is configured to move within the inner cavity while expelling a jet of water or other fluid into the inner cavity of the holding tank. In some embodiments, the jet of fluid is expelled from a distal end of the cleaning portion of the cleaning device, thereby causing the distal end of the cleaning portion to move erratically within the holding tank. In this way, the direction and orientation of the jet of fluid continuously changes as the cleaning device cleans the inner cavity of the holding tank. An impact feature positioned at or near the distal end of the cleaning portion impacts and bounces off inner surfaces of the holding tank, thereby assisting with the cleaning process. The jet of fluid is expelled at a predetermined angle (a “spray angle”) relative to a primary axis of the impact feature. By changing the spray angle, the movement of the distal end of the cleaning portion within the holding tank is also changed.

In some embodiments, the cleaning device is powered by a source of water or other fluid, such as a garden hose, a faucet, or the like. The cleaning device is configured to increase the velocity of the fluid as the fluid flows through the cleaning device such that the velocity of the jet of fluid expelled from the cleaning device is greater than the velocity of fluid flowing into the cleaning device.

Some embodiments of the present invention are cleaning systems that are installed to or integrated with a tank. In some embodiments, the system includes a single cleaning portion positioned within an inner cavity of the tank. In other embodiments, the system includes a plurality of cleaning portions positioned within the inner cavity, each having their own impact features and associated fluid outlets. In some such embodiments, the system includes fluid conduit extending from a single fluid inlet to each of the cleaning portions.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION OF THE DRAWINGS

Embodiments of the present invention are described in detail below with reference to the attached drawing figures, wherein:

FIG. 1 is a top view of an embodiment of the cleaning device of the present invention.

FIG. 2 is a top view of a cleaning portion of the cleaning device of FIG. 1.

FIG. 3 is a top view of a positioning portion of the cleaning device of FIG. 1.

FIG. 4A is a schematic view of a cleaning device and a tank, the spray angle of the cleaning device being five degrees.

FIG. 4B is a schematic view of a cleaning device, a tank, and a toilet base, the spray angle of the cleaning device being forty-five degrees.

FIG. 5A is a schematic view of a cleaning system installed to a tank, fluid conduit of the cleaning system extending from a single fluid inlet to each of two cleaning portions positioned within an inner cavity of the tank.

FIG. 5B is a schematic view of a cleaning system installed to a tank, the cleaning system having a single fluid inlet and a single cleaning portion positioned within an inner cavity of the tank.

The drawing figures do not limit the present invention to the specific embodiments disclosed and described herein. The drawings are not necessarily to scale, emphasis instead being placed upon illustrating the principles of the invention.

### DETAILED DESCRIPTION

As required, a detailed embodiment of the present invention is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

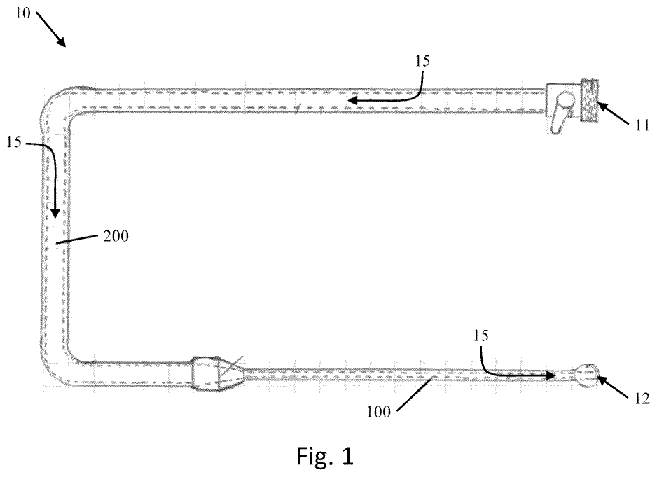

Referring to FIG. 1, the cleaning device 10 of the present invention includes a cleaning portion 100 extending from a positioning portion 200, each of which defines a portion of a fluid pathway 15. The fluid pathway 15 extends from a fluid inlet 11, which is positioned at or near a proximal end of the positioning portion 200, to a fluid outlet 12, which is positioned at or near a distal end of the cleaning portion 100.

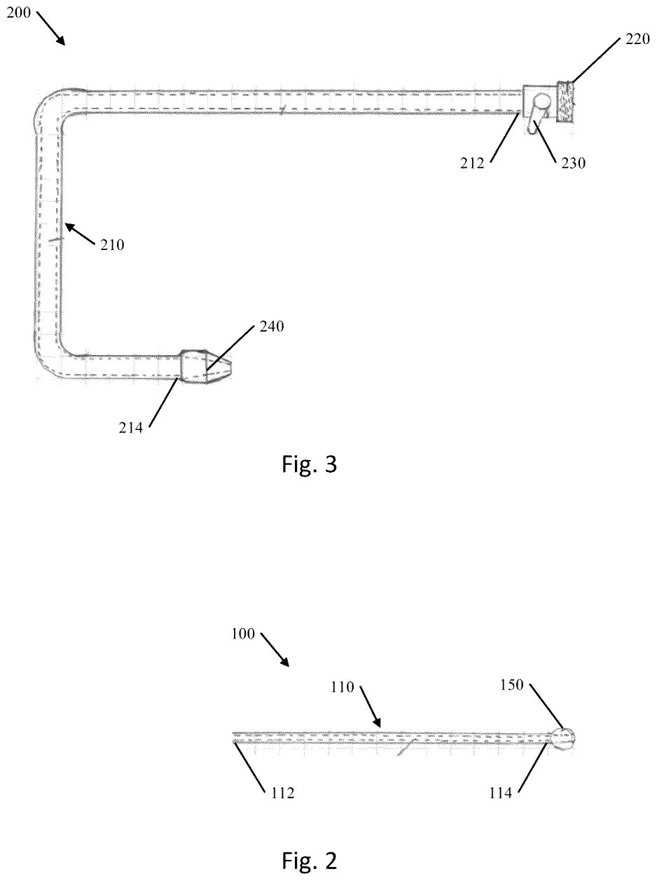

Referring to FIG. 2, the cleaning portion 100 includes primary tube 110 having opposed proximal 112 and distal 114 ends. The primary tube 110 defines a primary portion of the fluid pathway 15 (the “primary fluid pathway”), which facilitates fluid flow from the proximal end 112 of the primary tube 110 towards the distal end 114 of the primary tube 110. The fluid outlet 12 is in fluid communication with the primary fluid pathway, thereby facilitating fluid flow out of the cleaning device 10.

In some embodiments, the cross section of the fluid outlet 12 is the same as the cross section of the primary fluid pathway. In other embodiments, the cross section of the fluid outlet 12 is smaller than the cross section of the primary fluid pathway such that the velocity of fluid flowing through the fluid outlet 12 is greater than the velocity of fluid flowing through the primary fluid pathway. In some embodiments, the fluid outlet 12 is formed from a single aperture positioned at or near the distal end 114 of the primary tube 110. In other embodiments, the fluid outlet 12 includes a plurality of apertures. In some such embodiments, the cross-sectional area of the primary fluid pathway is greater than the aggregate cross-sectional area of the plurality of apertures.

The cleaning portion 100 of the cleaning device 10 includes an impact feature 150 coupled to the primary tube 110 at or near the distal end 114 of the primary tube 110. In some embodiments, the impact feature 150 is positioned just upstream of the fluid outlet 12. In other embodiments, the impact feature 150 defines at least part of the fluid outlet 12 and one or more fluid pathways extending between the fluid outlet 12 and the primary fluid pathway, thereby facilitating fluid communication between the fluid outlet 12 and the primary fluid pathway.

The impact feature 150 is configured to impact and bounce off an inner surface of a holding tank as fluid flows out of the fluid outlet 12. In some embodiments, the impact feature 150 is a hammer ball defining a spherical or nearly spherical outer surface. In some embodiments, the impact feature 150 includes a plurality of extrusions, such as spikes or the like, extending from an outer surface of the impact feature 150.

Referring to FIG. 3, the positioning portion 200 of the cleaning device 10 includes a secondary tube 210 having opposed proximal 212 and distal 214 ends. The secondary tube 210 extends from the proximal end 112 of the primary tube 110 and defines a secondary portion of the fluid pathway 15 (the “secondary fluid pathway”). In some embodiments, the primary and secondary fluid pathways are defined by respective first and second diameters, the first diameter being less than the second diameter such that the velocity of fluid flowing through the primary fluid pathway is greater than the velocity of fluid flowing through the secondary fluid pathway.

In some embodiments, the secondary tube 210 is formed from a resilient and durable material, such as materials used for garden hoses, industrial water hoses, or the like. In some embodiments, the secondary tube 210 has a length between approximately three and five feet. In other embodiments, the length of the primary 110 and secondary 210 tubes, combined, is between approximately three and five feet. The fluid inlet 11 is in fluid communication with the secondary fluid pathway, thereby facilitating fluid flow into the cleaning device 10.

In some embodiments, the positioning portion 200 includes a connection feature 220 coupled to the proximal end 212 of the secondary tube 210. In some such embodiments, the connection feature 220 includes a female hose connector, thereby facilitating connection of the cleaning device 10 to a fluid source, such as a garden hose, a faucet, or the like. In some embodiments, the connection feature 220 includes a flow valve 230 for selectively controlling the rate of fluid flow into the cleaning feature 10. In some such embodiments, the flow valve 230 includes a shut-off position for selectively stopping fluid from flowing into the cleaning feature 10. It will be appreciated that various embodiments of the present invention are configured to utilize various water sources that are known in the art to provide a steady flow of water and, thereby, achieve the purpose of the present invention. It will also be appreciated that various embodiments of the present invention are configured to utilize cleaning fluids that are suited to clean the inner cavity of a holding tank.

In some embodiments, the positioning portion 200 includes a concentrator 240 coupled to the distal end 214 of the secondary tube 210 such that the concentrator 240 is positioned between the primary 110 and secondary 210 tubes. The concentrator is configured to direct fluid from the secondary fluid pathway into the primary fluid pathway. In some embodiments, the concentrator 240 defines an inner passage having a frustoconical shape defined by primary and secondary diameters associated with the primary and secondary fluid pathways, respectively.

In some embodiments, the concentrator 240 defines an inlet and an opposing outlet, the inlet being located upstream of the outlet and having a greater diameter than the outlet. In such embodiments, the concentrator 240 forms a nozzle for increasing the velocity of fluid flowing through the primary tube 110 relative to the velocity of fluid flowing through the secondary tube 210.

In some embodiments, the primary tube 110 is formed from a semi-flexible material that is sufficiently flexible to allow the impact feature 150 to bounce from wall to wall of the holding tank. In some such embodiments, the semi-flexible material is sufficiently rigid so as to inhibit the primary tube 110 from kinking, tying itself into a knot, or otherwise inhibiting functionality of the cleaning portion 100 of the cleaning device 10 as the impact feature 150 bounces from wall to wall of the holding tank. In some embodiments, the semi-flexible material is a plastic material. It will be appreciated that various semi-flexible materials that achieve the purpose of the present invention, as they are known in the art, are utilized in various embodiments of the present invention.

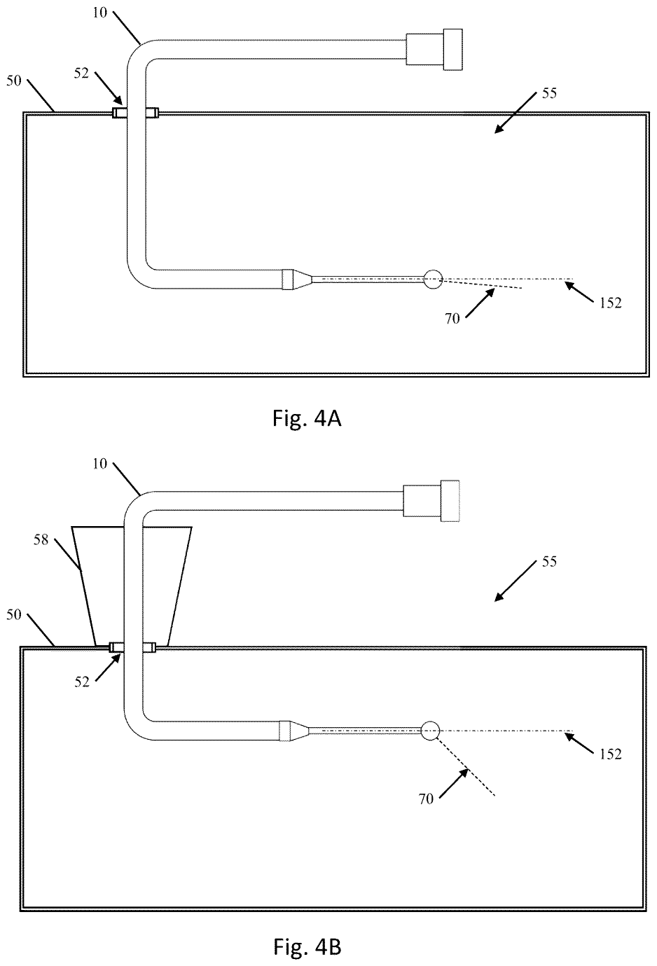

Referring to FIGS. 4A and 4B, the cleaning device 10 of the present invention is configured to extend into an inner cavity 55 of a tank 50 through an opening 52, such as the tank's drainage or inlet port, a toilet valve opening associated with a toilet base 58, or the like. In each embodiment shown, the cleaning portion is configured to spray a jet of fluid 70 at a predetermined angle (a “spray angle”) relative to a primary axis 152 of the impact feature 150. In some embodiments, the spray angle is between five degrees (see FIG. 4A) and forty-five degrees (see FIG. 4B). In some embodiments, the cleaning portion is adjustable such that the spray angle is capable of being changed to one of a plurality of spray angle options.

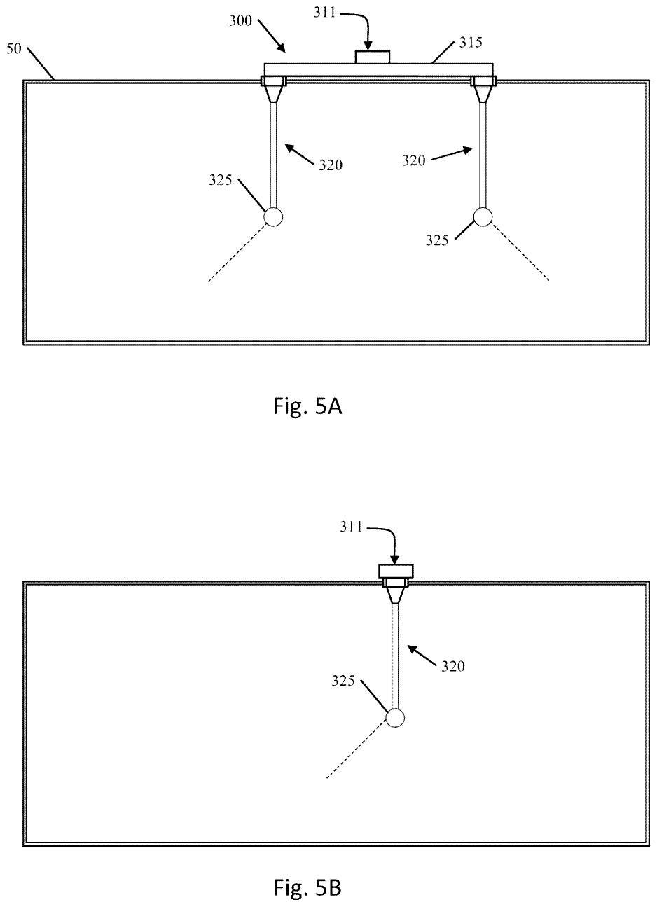

Referring to FIGS. 5A and 5B, some embodiments of the present invention include a cleaning system 300 that is integrated with, or configured to be coupled to, a tank 50. In the embodiment shown in FIG. 5A, fluid conduit 315 extends, at least partially, between a single fluid inlet 311 and a plurality of cleaning portions 320, a distal end of each cleaning portion having an impact feature 325 and defining a fluid outlet for directing a jet of fluid at a predetermined spray angle. The fluid conduit 315 defines at least part of a fluid pathway associated with the cleaning system 300. In the embodiment shown in FIG. 5B, the system includes a single fluid inlet 311 and a single cleaning portion 320. It will be appreciated that other configurations include more than two cleaning portions and/or a plurality of fluid inlets. It will further be appreciated that the quantity, size, and positioning of the cleaning portions can vary to satisfy specific needs.

The present invention also includes a method of using the cleaning device 10 of the present invention. The method includes positioning the cleaning portion of the cleaning device 10 within an inner cavity of a holding tank to be cleaned, such as by extending the cleaning device 10 through the holding tank's drainage or inlet port, through a toilet coupled to the holding tank, or otherwise extending the cleaning device 10 into the inner cavity of the holding tank. The method also includes flowing fluid through the cleaning device 10 such that a jet of fluid flows out of the fluid outlet 12 and into the inner cavity of the holding tank. In some embodiments, increased fluid velocity associated with reduced cross-sectional areas results in increased jet pressure of the fluid flowing into the inner cavity of the holding tank. In some embodiments, the length of the primary tube 110 is sufficient to facilitate the jet of fluid reaching all, or nearly all, areas of an interior surface of the holding tank.

In some embodiments, the expulsion of fluid associated with the jet of fluid causes the impact feature 150 to move around erratically within the inner cavity of the holding tank. In some embodiments, the erratic movement of the impact feature 150 causes the impact feature 150 and the jet of fluid to contact various portions of the interior surface of the holding tank repeatedly and from different angles. This erratic movement causes the cleaning actions of the present invention to reach and clean, in a short amount of time, a significant portion of the inner cavity of the holding tank. In some embodiments, a spray angle of the jet of fluid is between five and forty-five degrees. In some embodiments, the method includes adjusting the spray angle and/or the fluid flow to accommodate a first cleaning operation, such as for a first cleaning tank, and then readjusting the spray angle and/or the fluid flow to accommodate a second cleaning operation, such as for a second cleaning tank, a second area of the first cleaning tank, or after determining that the first setting(s) were not satisfactory for the first cleaning operation.

In some embodiments, the impact feature 150 is formed from a resilient material that allows for the impact feature 150 to repeatedly impact interior surfaces of the holding tank without sustaining or causing damage. In some such embodiments, the resilient material also has sufficient elasticity to cause the impact feature 150 to bounce off the interior surfaces of the holding tank. In some embodiments, the repeated impacts to the interior surfaces of the holding tank helps to dislodges debris within the holding tank or otherwise provides a cleaning action beyond the cleaning action of the jet of fluid. In some embodiments, a plurality of extrusions, such as spikes or the like, extending from an outer surface of the impact feature 150 provides additional cleaning actions and/or otherwise improves the cleaning actions of the present invention.

In some embodiments, the method of using the cleaning device 10 includes interrupting the flow of fluid through the cleaning device, such as by turning off a water source after a portion of the holding tank has been sufficiently cleaned. In some such embodiments, the method further comprises utilizing the positioning portion 200 of the cleaning device 10 to reposition the cleaning portion 100 of the cleaning device 10 while retaining the cleaning portion 100 of the cleaning device 10 within the inner cavity of the holding tank. In some such embodiments, the repositioning step is accomplished while the fluid flow is interrupted. After repositioning the cleaning portion, the flow of fluid is reintroduced, thereby facilitating additional cleaning actions on the same or different interior surfaces associated with the previous cleaning actions. Upon completion of all cleaning steps, the flow of fluid is interrupted, and the cleaning device is removed from the tank. In some such embodiments, the positioning portion 200 of the cleaning device 10 remains completely or substantially outside of the holding tank such that the positioning portion 200 of the cleaning device 10 remains clean and sanitary despite the conditions within the holding tank.

It will be appreciated that all embodiments of the cleaning device 10 as herein described are capable of performing at least one embodiment of the method of cleaning a holding tank herein described. It will also be appreciated that, although the present invention has been described in reference to usage for cleaning wastewater holding tanks, such reference should not be read as a limitation of the present invention. It will be appreciated that the present invention is capable of use in cleaning various other tanks, as are known in the art.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall within the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

What is claimed is:

1. A cleaning device comprising a positioning portion and a cleaning portion extending therefrom, the positioning portion comprising:
a primary tube having opposed proximal and distal ends, the proximal end of the primary tube defining a proximal end of the cleaning portion; and
an impact feature coupled to the distal end of the primary tube, thereby forming a distal end of the cleaning portion,
wherein the cleaning device defines a fluid inlet and a fluid outlet, the fluid inlet being associated with a proximal end of the positioning portion, and the fluid outlet being associated with the distal end of the cleaning portion,
wherein the cleaning device defines a fluid pathway for directing fluid from the fluid inlet to the fluid outlet, and
wherein the fluid outlet is configured and positioned such that the fluid exits the cleaning device as a stream of fluid directed at a spray angle relative to a primary axis of the impact feature.

2. The cleaning device of claim 1, wherein the spray angle is between five degrees and forty-five degrees.

3. The cleaning device of claim 2, wherein the cleaning device is configured such that the impact feature impacts and bounces off inner surfaces of a holding tank as the fluid flows out of the fluid outlet, thereby facilitating the impact feature bouncing from wall to wall of the holding tank.

4. The cleaning device of claim 3, wherein the impact feature is a hammer ball defining a spherical or nearly spherical outer surface.

5. The cleaning device of claim 4, wherein the impact feature comprises a plurality of extrusions extending from the outer surface of the impact feature.

6. The cleaning device of claim 5, wherein the primary tube of the cleaning portion is formed from a semi-flexible material that is sufficiently flexible to allow the impact feature to bounce from wall to wall of the holding tank, and wherein the primary tube is sufficiently rigid to inhibit the primary tube from kinking or tying itself into a knot.

7. The cleaning device of claim 6, wherein the positioning portion comprises a flow valve for controlling the amount of fluid flowing through the fluid pathway, thereby influencing impact force, and impact feature trajectories, associated with the impact feature bouncing from wall to wall of the holding tank.

8. The cleaning device of claim 7, wherein the fluid outlet is adjustable such that the spray angle is capable of being changed to one of a plurality of spray angle options, thereby further influencing the impact force, and the impact feature trajectories, associated with the impact feature bouncing from wall to wall of the holding tank.

9. The cleaning device of claim 8, further comprising:
a concentrator coupling the cleaning portion to the positioning portion,
wherein the fluid pathway comprises primary and secondary portions, the primary portion of the fluid pathway being defined by the primary tube of the cleaning portion, and the secondary portion of the fluid pathway being defined by a secondary tube of the positioning portion, and
wherein a cross-sectional area of the primary portion is smaller than a cross-sectional area of the secondary portion, and
wherein the concentrator defines an inner passage having a frustoconical shape defined by primary and secondary diameters associated with the primary and secondary portions, respectively, of the fluid pathway.

10. The cleaning device of claim 1, wherein the spray angle is forty-five degrees.

11. A method of using a cleaning device to clean an inner cavity of a holding tank, the method comprising:
positioning a cleaning portion of the cleaning device within the inner cavity of the holding tank, wherein the cleaning portion comprises:
a primary tube having opposed proximal and distal ends, the proximal end of the primary tube defining a proximal end of the cleaning portion; and
an impact feature coupled to the distal end of the primary tube, thereby forming a distal end of the cleaning portion,
flowing fluid through a fluid pathway of the cleaning device to a fluid outlet of the cleaning device, the fluid outlet being configured and positioned such that the fluid exits the cleaning device as a stream of fluid directed at a spray angle relative to a primary axis of the impact feature; and
continuing to flow fluid through the fluid pathway and out of the fluid outlet while the impact feature impacts and bounces off inner surfaces of the holding tank, thereby facilitating the impact feature bouncing from wall to wall of the holding tank.

12. The method of claim 11, wherein the spray angle is between five degrees and forty-five degrees.

13. The method of claim 12, wherein the impact feature is a hammer ball defining a spherical or nearly spherical outer surface.

14. The method of claim 13, wherein the impact feature comprises a plurality of extrusions extending from the outer surface of the impact feature.

15. The method of claim 14, wherein the primary tube of the cleaning portion is formed from a semi-flexible material that is sufficiently flexible to allow the impact feature to bounce from wall to wall of the holding tank, and wherein the primary tube is sufficiently rigid to inhibit the primary tube from kinking or tying itself into a knot.

16. The method of claim 15, further comprising:
adjusting the amount of fluid flowing through the fluid pathway, thereby influencing impact force, and impact feature trajectories, associated with the impact feature bouncing from wall to wall of the holding tank; and
adjusting the spray angle, thereby further influencing the impact force, and the impact feature trajectories, associated with the impact feature bouncing from wall to wall of the holding tank.

17. The method of claim 11, wherein the spray angle is forty-five degrees.

18. A holding tank with a cleaning system having at least one cleaning portion positioned within an inner cavity of the holding tank, the cleaning portion comprising:
a primary tube having opposed proximal and distal ends, the proximal end of the primary tube defining a proximal end of the cleaning portion; and
an impact feature coupled to the distal end of the primary tube, thereby forming a distal end of the cleaning portion,
wherein the cleaning system defines a fluid inlet and a fluid outlet, the fluid inlet being associated with the holding tank, and the fluid outlet being associated with the distal end of the cleaning portion,
wherein the cleaning system defines a fluid pathway for directing fluid from the fluid inlet to the fluid outlet, and
wherein the fluid outlet is configured and positioned such that the fluid exits the cleaning device as a stream of fluid directed at a spray angle relative to a primary axis of the impact feature.

19. The cleaning system of claim 18, wherein the cleaning system comprises a plurality of cleaning portions, each cleaning portion having respective fluid outlets, and each fluid outlet being in fluid communication with the fluid pathway.

20. The cleaning system of claim 19, wherein the spray angle for each cleaning system is between five degrees and forty-five degrees.
